(19) United States
(12) Patent Application Publication
(10) Pub. No.: US 2002/0049748 A1
(43) Pub. Date: Apr. 25, 2002

(54) File management apparatus and recording medium on which a file management program is recorded

(75) Inventors: Yoichi Iki, Tokyo (JP); Hiroko Saito, Yokosuka-shi (JP)

Correspondence Address: OLIFF & BERRIDGE, PLC, P.O. BOX 19928, ALEXANDRIA, VA, 22320, US

(73) Assignee: NIKON CORPORATION

(21) Appl. No.: 09/808,141

(22) Filed: Mar. 15, 2001

(30) Foreign Application Priority Data
Apr. 5, 2000 (JP) 2000-104023

(51) Int. Cl. G06F 7/00

(52) U.S. Cl. 707/2

(57) ABSTRACT

The invention relates to a file management apparatus for performing file management using file names, and is intended to provide a file management apparatus that allows handling of files by simple operations. The file management apparatus has a structure information setting section, a data acquiring section, a name-generating section, and a managing section. The structure information setting section arbitrarily sets structure information that defines structure of file names. The data acquiring section acquires data to be stored as a file. The name-generating section acquires, for each data acquired by the data acquiring section, information structuring a file name according to the structure information set by the structure information setting section, and generates a file name using the acquired information. The managing section stores the data acquired by the data acquiring section, and manages the data using the file names generated by the name-generating section.

### BACKGROUND OF THE INVENTION

1. Field of the Invention

The present invention relates to a file management apparatus for performing file management using file names as well as to a computer-readable recording medium on which a file management program for realizing such file management on a computer is recorded.

2. Description of the Related Art

Conventionally, the function of managing files by file names is realized by the OS (operating system) of a computer. When image data or text data are stored as a file according to such file management, a file name and a directory name are given to the file.

For example, when photographing is commanded by an operator, an image data is acquired by an electronic camera in systems in which image data generated by an electronic camera are stored as files in personal computers. The operator is urged to input a file name and a directory name of the image data, or a file name consisting of a pre-input character string and a serial number is automatically generated.

An example of such a system is a microscope system that consists of an electronic camera for generating image data by photographing a sample through a microscope and a personal computer for storing the image data as a file. In the following description, image data that are generated by an electronic camera in a microscope system will be called “microscope image data”.

In general electronic cameras, image data are stored inside as a file. In such electronic cameras, every time image data are generated, a file name having a predetermined format is automatically given to a file corresponding to the image data. In such electronic cameras, a file name consisting of a fixed character string and a serial number is usually generated. Therefore, even when files are transferred to a personal computer, the personal computer can uniquely handle each file.

In view of convenience in searching for a file, it is desirable that a file name and a directory name be names that reflect a characteristic of the data of the corresponding file. If each file name reflects a characteristic of the corresponding data, the user using the files can retrieve a desired file merely by referring to its file name or deal with a plurality of files by classifying them based on characteristic differences.

However, the format of a file name (including a directory name) that is generated by electronic cameras and the above-described microscope system is limited to a fixed character string plus a serial number. Such a file name is not suitable for file search or classification. When a user using files desires to change such file names to ones suitable for searching and classifying, he needs to sequentially reproduce all files and extract characteristics of the data in the respective files. The user is forced to perform very cumbersome operations.

### SUMMARY OF THE INVENTION

A first object of the present invention is to provide a file management apparatus that allows handling of files by simple operations.

A second object of the invention is to provide a recording medium on which a file management program that allows handling of files by simple operations is recorded.

To attain the first object, the invention provides a file management apparatus comprising: a structure information setting section capable of arbitrarily setting structure information that defines structure of a file name; a data acquiring section for acquiring data to be stored as a file; a name-generating section for acquiring, for each data acquired by the data acquiring section, information structuring a file name, according to the structure information that is set by the structure information setting section, and for generating a file name using the acquired information; and a managing section for storing the data acquired by the data acquiring section, and for managing the data using the file name generated by the name-generating section.

Also to attain the first object, the invention provides another file management apparatus comprising: a data acquiring section for acquiring stored data to which a file name is given in advance and information that is associated with the stored data; a structure information setting section capable of arbitrarily setting structure information that defines structure of a virtual file name; and a name-generating section for acquiring, for each data acquired by the data acquiring section, information structuring a virtual file name according to the structure information that is set by the structure information setting section, and for generating a virtual file name using the acquired information, wherein the data acquired by the data acquiring section are managed by using the virtual file name generated by the name-generating section.

To attain the second object, the invention provides a computer readable medium storing a file management program to control a computer, said program comprising the steps of: setting arbitrarily structure information that defines structure of a file name; acquiring data to be stored as a file; acquiring, for each data acquired by the data acquiring step, information structuring a file name according to the structure information that is set by the structure information setting step, and generating a file name using the acquired information; and storing the data acquired by the data acquiring step, and managing the data using the file name generated by the name-generating step.

Also to attain the second object, the invention provides a computer readable medium storing a file management program to control a computer, said program comprising the steps of: acquiring stored data to which a file name is given in advance and information that is associated with the stored data; setting arbitrarily structure information that defines structure of a virtual file name; and acquiring, for each data acquired by the data acquiring step, information structuring a virtual file name, according to the structure information that is set by the structure information setting step, and generating a virtual file name using the acquired information, wherein the data acquired by the data acquiring step are managed by using the virtual file names generated by the name-generating step.

### BRIEF DESCRIPTION OF THE DRAWINGS

The nature, principle, and utility of the invention will become more apparent from the following detailed description when read in conjunction with the accompanying drawings in which like parts are designated by identical reference numbers, in which:

FIG. 1 is a configuration showing first to third embodiments of microscope systems according to the present invention;

FIG. 2 shows a first embodiment of an exemplary file name setting screen according to the present invention;

FIG. 3 is a table showing an example of parameters to be included in structure information;

FIGS. 4-6 are operation flowcharts showing a first embodiment of the microscope system according to the present invention;

FIGS. 7A-1, 7A-2, 7B-1, and 7B-2 show examples of hierarchical file structures corresponding to two respective pieces of structure information;

FIGS. 8A and 8B show an example of a hierarchical file structure corresponding to two pieces of structure information;

FIG. 9 is an operation flowchart showing a second embodiment of the microscope system according to the present invention;

FIG. 10 is an operation flowchart showing a third embodiment of the microscope system according to the present invention;

FIGS. 11A-11C shows a third embodiment of exemplary reclassification-setting screens according to the present invention;

FIGS. 12A-12D shows a third embodiment of other exemplary reclassification-setting screens according to the present invention; and

FIGS. 13A-13C show a result of reclassification processing.

### DESCRIPTION OF THE PREFERRED EMBODIMENTS

Embodiments of the present invention will be hereinafter described with reference to the accompanying drawings. Each of the following embodiments is directed to file management in a microscope system having a personal computer.

In each of the embodiments, the personal computer corresponds to a file management apparatus according to the invention. A file management program recorded in a recording medium according to the invention is installed in advance in the personal computer.

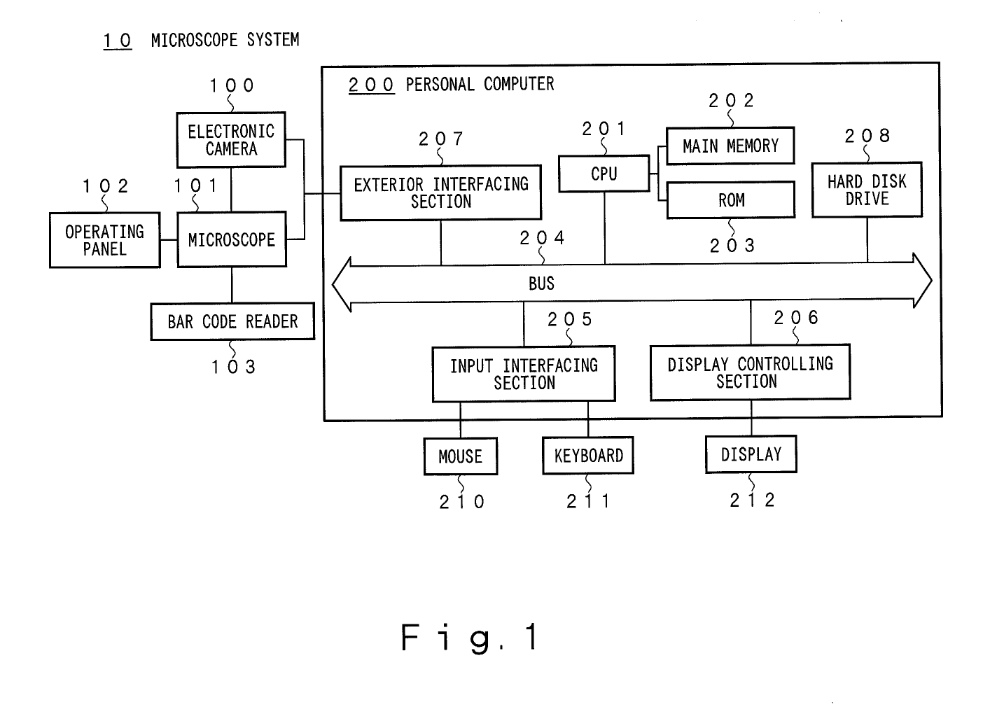

FIG. 1 is a configuration showing first to third embodiments of microscope systems according to the invention.

As shown in FIG. 1, the microscope system 10 is provided with a microscope 101 having an electronic camera 100 for generating microscope image data by photographing a sample and a personal computer 200.

An operating panel 102 and a bar code reader 103 are connected to the microscope 101. The operating panel 102 accepts setting of photographing conditions of the electronic camera 100 that are made by an operator, setting of adjustment quantities of adjustment subject portions (e.g., a motor-operated revolver and a motor-operated stage), etc. The bar code reader 103 reads a bar code that is attached to a prepared slide on which a sample is placed.

The microscope 101 incorporates a control section (not shown).

The control section has a function of automatically controlling the electronic camera 100 or automatically controlling the adjustment subject portions of the microscope 101 in accordance with various settings accepted by the operating panel 102. The control section has a function of managing information (e.g., a sample ID) indicated by a bar code that is read by the bar code reader 103. The control section also has a function of collecting, when a sample is photographed by the electronic camera 100, information indicated by the bar code that is attached to the prepared slide on which the sample is placed, a date and time of the photographing, photographing conditions of the electronic camera 100, information indicating the states of the adjustment subject portions of the microscope 101, and other information. Information thus collected is information suitable for management of microscope image data. Therefore, such information will be called “image management information”.

The personal computer 200 has a CPU 201 for performing file management (described later).

A main memory 202 and a ROM 203 are connected to the CPU 201. Further, an input interfacing section 205, a display controlling section 206, an exterior interfacing section 207, and a hard disk drive 208 are connected to the CPU 201 via a bus 204. The input interfacing section 205 is connected to a mouse 210 and a keyboard 211. The display controlling section 206 is connected to a display 212. The exterior interfacing section 207 is connected to the electronic camera 100 and the control section inside the microscope 101.

In the microscope system 10 having the above configuration, microscope image data generated by the electronic camera 100 are stored as a file. In the following description, such a file will be called “microscope image file”.

In the first embodiment, every time a photograph is taken, microscope image data generated by the electronic camera 100 is supplied to the personal computer 200 via the exterior interfacing section 207 and stored in the hard disk drive 208 as a microscope image file.

The personal computer 200 is also provided with an OS that uses a GUI (graphical user interface).

The display controlling section 206 displays an operation screen on the display 212 according to instructions from the CPU 201.

### Embodiment 1

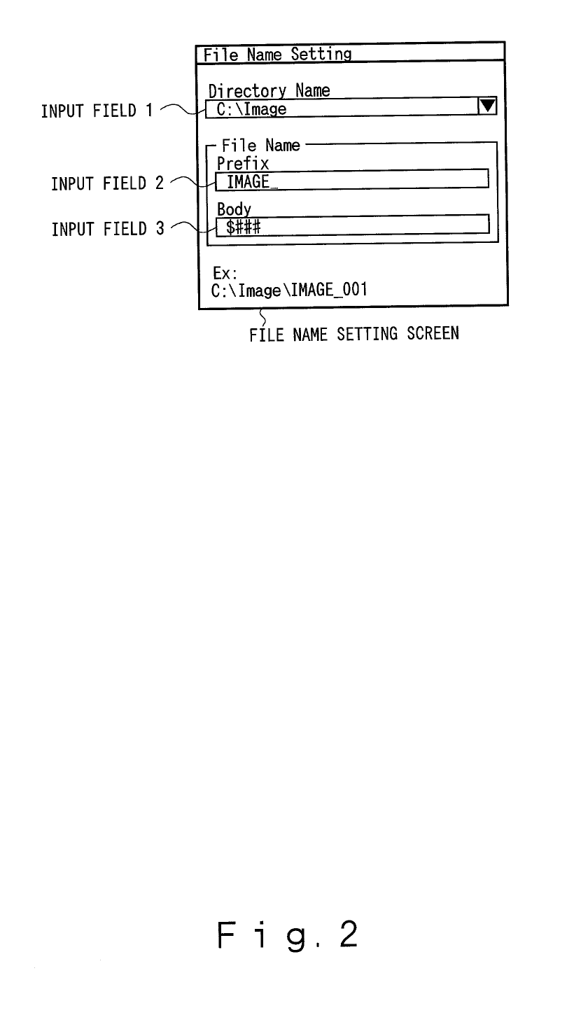

FIG. 2 shows a first embodiment of an exemplary file name setting screen among operation screens according to the present invention.

The file name setting screen is an operation screen for accepting setting of a directory where a microscope image file is to be stored and input of a file name of the microscope image file in the directory. A file name that is input through the file name setting screen does not include a directory name. Directories that are set through the file name setting screen may have a hierarchical structure.

In the file name setting screen, input field-1 accepts input of a directory name by an operator. Input field-2 and input field-3 are accepts input of a file name. More specifically, input field-2 accepts input of a fixed character string (hereinafter referred to as “prefix characters”) to serve as the head portion of a file name. Input field-3 accepts input of a character string (hereinafter referred to as “body characters”) to follow the prefix characters.

Whereas input field-1 and input field-3 accepts input of a character string as a directory name itself or a character string as a file name itself as in the case of the prior art, they also accepts input of structure information unlike the case of the prior art.

The structure information is information that defines the structure of a directory name or a file name according to prescribed rules. In the first embodiment, the structure information is a character string including a plurality of parameter names and a prescribed division character (e.g., “_” or “\”).

FIG. 3 is a table showing an example of parameters to be included in structure information.

FIG. 3 shows parameter names and their respective meanings. FIG. 3 also shows character strings (hereinafter referred to as “actual character strings”) that are actually assigned to the respective parameter names. In FIG. 3, “$###” is a parameter name that means a 3-figure serial number in the same directory. The number of #'s is not limited to three and can be increased or decreased in accordance of the number of figures of a serial number.

Such an actual character string is generated by processing to be described later. At this time, the CPU 201 acquires, in accordance with each parameter name, information (hereinafter referred to as “parameter information”) that is necessary to generate a corresponding actual character string.

For example, in generating actual character strings corresponding to “$YYYY”, “$YY”, “$MM”, “$MMM”, “$DD”, “$24”, “$12”, “$mm”, “$ss”, “$MAG”, and “$ID”, the CPU 202 acquires, as parameter information, a photographing date and time, a magnification, and a sample ID from image management information that was collected by the control section of the microscope 101. In generating actual character strings corresponding to “$USER”, “$PRJ”, “$?“Input xxx””, the CPU 201 acquires, as parameter information, a user name, a project name, and an arbitrary character string that are input by an operator.

In the processing to be described later, the CPU 201 generates a file name example (including a directory name) corresponding to structure information. Character strings (hereinafter referred to as “sample character strings”) as samples of actual character strings to be used in generating a file name example are stored in advance in a prescribed area of the hard disk drive 208 in the form of a table so as to be correlated with the respective parameter names.

In the following description, parameters such as “$USER”, “$PRJ”, and “$?“Input xxx”” that need to be input by an operator in generating an actual character string will be called “user-input parameters”.

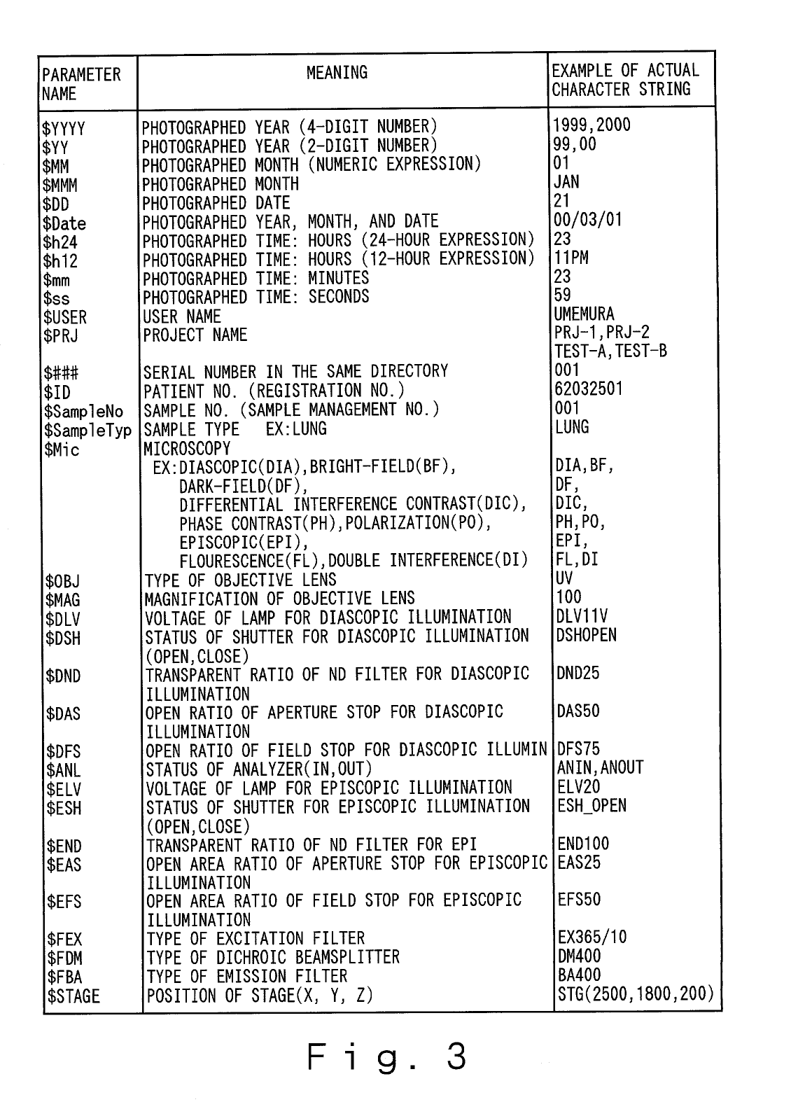

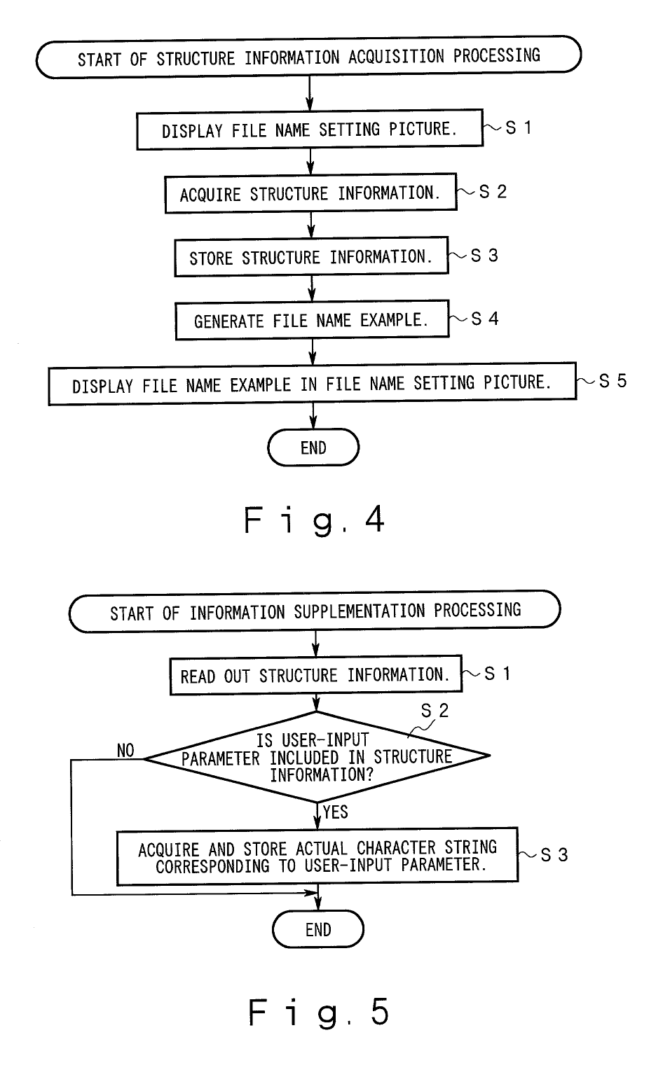

FIGS. 4-6 are operation flowcharts showing a first embodiment of the microscope system 100 according to the present invention.

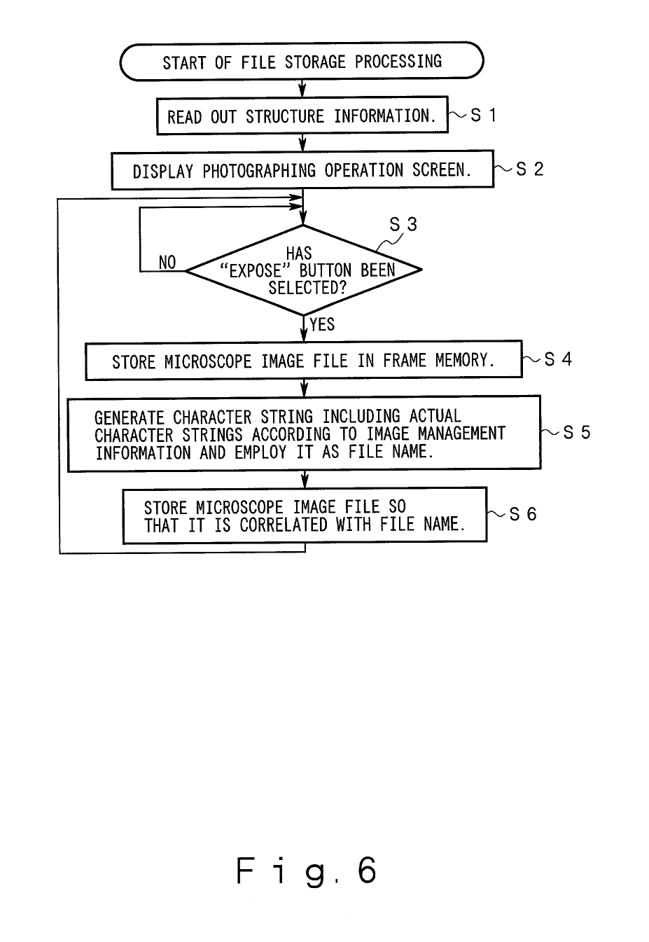

FIG. 4 shows processing (hereinafter referred to as “structure information acquisition processing”) for acquiring structure information among various kinds of file management processing that are performed by the CPU 201. FIG. 5 shows processing (hereinafter referred to as “information supplementation processing”) for supplementing structure information among the various kinds of file management processing that are performed by the CPU 201. FIG. 6 shows processing (hereinafter referred to as “file storage processing”) for storing a microscope image file among the various kinds of file management processing that are performed by the CPU 201.

Each of the three kinds of processing shown in FIGS. 4-6 is performed in a state that a command corresponding to it has been selected by an operator. The kinds of file management processing (e.g., processing of searching for a microscope image file corresponding to a path name that is input by an operator) other than those shown in FIG. 4-6 are realized according to the OS and hence will not be illustrated nor described.

The operations of the microscope system 10 according to the first embodiment will be described below.

However, since the essential features of the invention reside in the file management that is performed by the CPU 201, in the following operations of the CPU 201 will be described with reference to FIGS. 4-6 and the other operations will not be described.

<Structure Information Acquisition Processing>

When a command corresponding to the structure information acquisition processing is selected by an operator, at step S1 in FIG. 4 the CPU 201 instructs the display controlling section 206 to display a file name setting screen.

When a file name setting screen is displayed on the display 212, at step S2 in FIG. 4 the CPU 201 acquires structure information that is input by the operator.

At step S3 in FIG. 4, the CPU 201 stores the acquired structure information in a prescribed area of the hard disk drive 208.

At step S4 in FIG. 4, the CPU 201 analyzes the structure information and acquires, from the parameter table, sample character strings corresponding to the parameter names included in the structure information. The CPU 201 assigns the sample character strings to the parameter names in the structure information and generates a file name example (including a directory name).

For example, assume that parameter names and sample character strings are correlated with each other in the following manner in the parameter table:

$USER→UMEMURA

$YYYY→2000

$MM→02

$DD→23

$ID→9999

$###→001

If “C: \IMAGE\$USER ” is input as a directory name and “$YYYY$MM$DD_$ID_$###” is input as body characters of a file name, the CPU 201 generates

“C:\IMAGE\UMEMURA\20000223_9999_001”

as a character string of a file name example (including the directory name).

After generating the file name example (including the directory name) in this manner, at step S5 in FIG. 4, the CPU 201 instructs the display controlling section 206 to display the file name example in the file name setting screen.

In the structure information acquisition processing, if a user-input parameter is included in structure information that is acquired at step S2 in FIG. 4, input of plural kinds of actual character strings that can correspond to the user-input parameter may be accepted. For example, if structure information including “$USER” is input, input of all names that can be a user of the microscope system 10 may be accepted.

<Information Supplementation Processing>

When a command corresponding to the information supplementation processing is selected by an operator, at step S1 in FIG. 5 the CPU 201 reads out structure information from the hard disk drive 208.

At step S2 in FIG. 5, the CPU 201 analyzes the structure information and judges whether a user-input parameter is included in the structure information.

At step S3 in FIG. 5, if judging that a user-input parameter is included in the structure information, the CPU 201 instructs the display controlling section 206 to display an operation screen (e.g., an operation screen for accepting input of a user name, a project name, an arbitrary character string, or the like) for accepting input of an actual character string corresponding to the user-input parameter. When such an operation screen is displayed on the display 212, the CPU 201 acquires an actual character string that is input by the operator and corresponds to the user-input parameter and stores the actual character string in the hard disk drive 208.

If plural kinds of actual character strings that can correspond to the user-input parameter were input in the structure information acquisition processing, the CPU 201 may acquire, as an actual character string corresponding to the user-input parameter, one of the plural kinds of actual character strings that is selected by the operator.

The above information supplementation processing may be performed in the file storage processing (described later) before or after the first photographing or every time photographing is performed.

For example, where information supplementation processing is performed at every photographing, the storage destination drive or the actual character string corresponding to a user-input parameter could be changed for each microscope image file. In particular, where input of an actual character string corresponding to “$?“Input xxx”” is accepted at every photographing, an operator can input different character strings for respective microscope images files. Therefore, the operator can distinguish individual microscope image files using those character strings.

<File Storage Processing>

When a command corresponding to the file storage processing is selected by an operator, at step S1 in FIG. 5 the CPU 201 reads out structure information from the hard disk drive 208.

At step S2 in FIG. 6, the CPU 201 instructs the display controlling section 206 to display an operation screen (hereinafter referred to as “photographing operation screen”) that relates to photographing of a sample.

The photographing operation screen has a “Expose” button for accepting a photographing instruction from an operator. To urge an operator at step S3 in FIG. 6 to confirm an actual character string corresponding to a user-input parameter that is stored in the hard disk drive 208, the photographing operation screen may have a region in which to display such an actual character string.

For example, when “$USER” is included in the directory name of structure information, a user name is displayed in the above region and the operator is urged to confirm the user name. This prevents a microscope image file from being stored erroneously in a directory of another person.

When a photographing operation screen is displayed on the display 212, at step S3 in FIG. 6 the CPU 201 judges whether the “Expose” button has been selected.

If judging that the “Expose” button has been selected, at step S4 in FIG. 6 the CPU 201 instructs the electronic camera 100 to generate microscope image data. Further, the CPU 201 instructs the control section of the microscope 101 to collect image management information. In response, for example, the control section of the microscope 101 collects, as image management information, information indicated by the bar code that is attached to the prepared slide on which a sample is placed, a date and time of photographing, photographing conditions of the electronic camera 100, information indicating the states of the adjustment subject portions of the microscope 101.

The CPU 201 acquires, via the microscope interfacing section 207, the microscope image data that were generated by the electronic camera 100, and stores it in a frame memory (not shown) as a microscope image file.

At step S5 in FIG. 6, the CPU 201 analyzes the structure information, generates, according to the image management information, actual character strings corresponding to the respective parameters that are included in the structure information, and employs a character string consisting of the actual character strings as a file name (including a directory name).

If a user-input parameter is included in the structure information, the CPU 201 assigns, to the user-input parameter, an actual character string that was stored in the hard disk drive 208 at step S3 in FIG. 5. If “$###” is included in the structure information, the CPU 201 generates a 3-figure number based on the number of microscope image files in a directory to which “$###” belongs and assigns it to “$###”.

At step S6 in FIG. 6, the CPU 201 stores the microscope image file that was stored in the frame memory at step S4 in FIG. 6 so as to be correlated with the file name that was generated at step S5 in FIG. 6.

If there is no directory corresponding to the directory name that is included in the file name that was generated at step S5 in FIG. 6, the CPU 201 generates a new directory and stores the microscope image file in the new directory.

After storing the microscope image file at step S6 in FIG. 6, the CPU 201 repeatedly executes steps S3-S6 in FIG. 6.

That is, every time photographing is performed by the electronic camera 100, the CPU 201 acquires microscope image data in the form of a microscope image file and generates, for the microscope image file, a file name (including a directory name) corresponding to structure information. The CPU 201 stores the microscope image file so that it is correlated with the file name.

For example, if a parameter (e.g., “$MAG” or “$FILTER”) relating to a photographing condition is included in structure information, when the photographing conditions vary as photographing is repeated the CPU 201 stores each microscope image file while giving a file name (including a directory name) that reflects such a change to it. If a parameter (e.g., “$ID” or “$SampleNo”) relating to sample identification is included in structure information, when another sample becomes an object of photographing as photographing is repeated the CPU 201 stores each microscope image file while giving a file name (including a directory name) that reflects a sample difference to it.

With the above operation, in the microscope system 10 according to the first embodiment, if the manager of the microscope system 10 inputs in advance structure information including parameters that correspond to information relating to the photographing conditions and sample identification, a user of the microscope system 10 need not input a file name (including a directory name) at the time of storing a microscope image file.

In the microscope system 10 according to the first embodiment, file names having various formats can be generated automatically depending on the contents of structure information in contrast to the conventional case in which the format of automatically generated file names is limited to a predetermined one.

That is, according to the first embodiment, a file name (directory name) that reflects desired information can be given to a microscope image file by performing simple operations.

In the first embodiment, if “$USER” was included in the directory name of structure information that was acquired in the structure information acquisition processing, in the file storage processing a plurality of microscope image files that are acquired as photographing is repeated are stored in the directory corresponding to a user name that is acquired in the information supplementation processing.

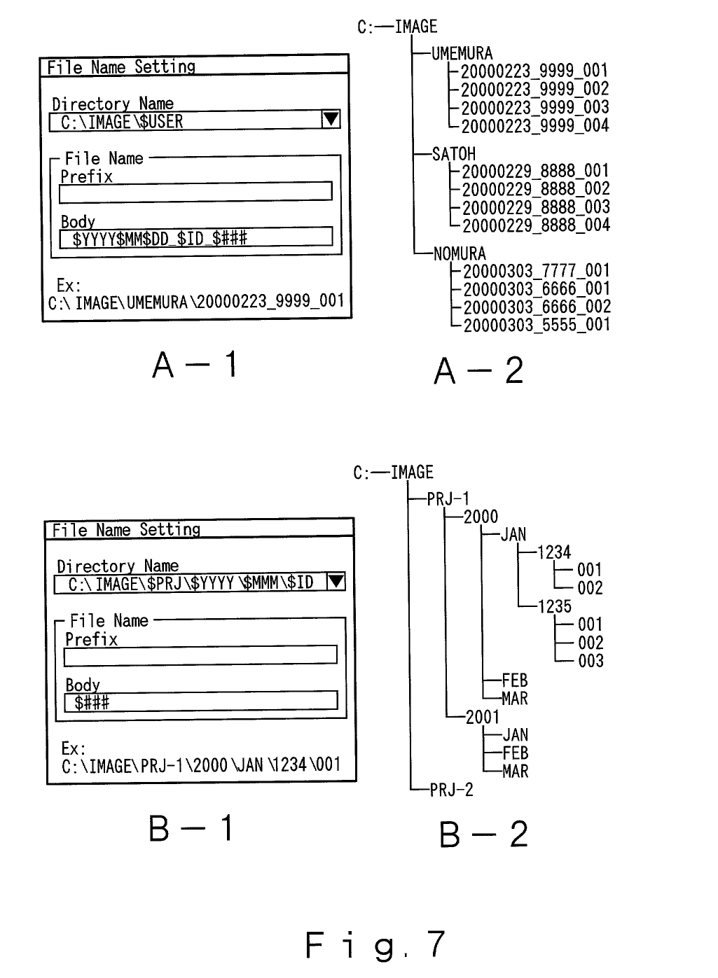

Therefore, according to the first embodiment, if structure information including “$USER” in a directory name is input in advance by the manager of the microscope system 10 as shown in FIG. 7A-1, when a user name is input by each user of the microscope system 10, microscope image files can be classified according to a hierarchical file structure with user-by-user classification as shown in FIG. 7A-2. Alternatively, if structure information as shown in FIG. 7B-1 and individual project names are input, microscope image files can be classified according to a hierarchical file structure as shown in FIG. 7B-2.

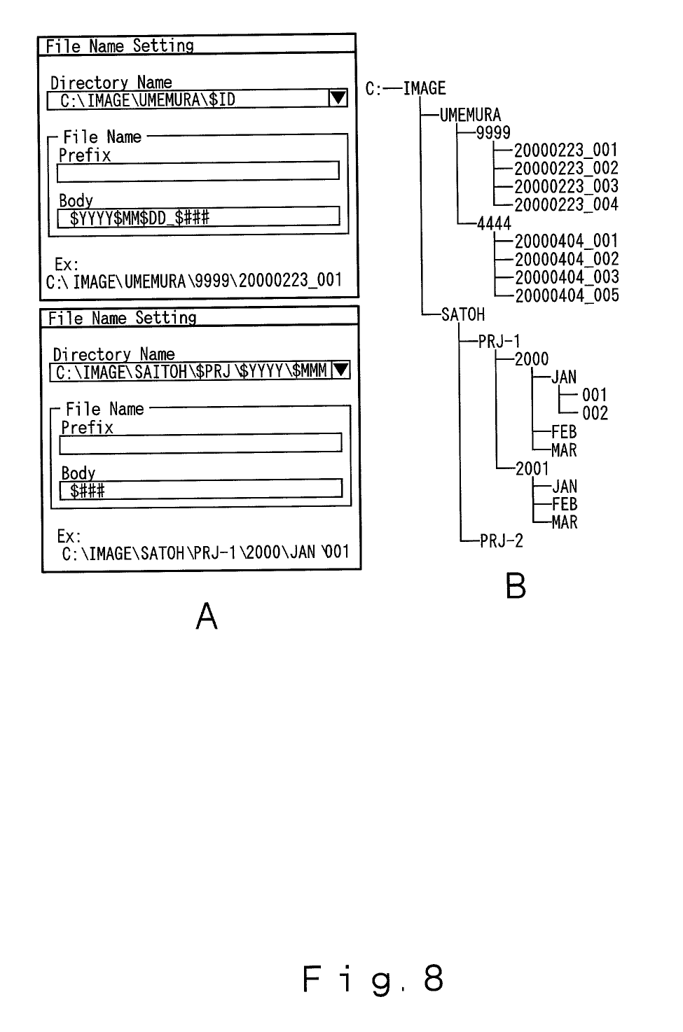

The first embodiment makes it possible to accept input of plural pieces of structure information. Therefore, it two pieces of structure information as shown in FIG. 8A are input, microscope image files can be classified according to hierarchical file structures that are different for respective directories as shown in FIG. 8B. However, where hierarchical file structures are different for respective directories, it is necessary for a user of the microscope system 10 to set in advance in which directory each microscope image file should be stored.

As described above, according to the first embodiment, a directory name according to a desired hierarchical file structure can be given to each microscope image file by performing simple operations. Therefore, in reproducing a desired microscope image file, the manager or a user of the microscope system 10 according to the first embodiment can easily retrieve it by referring to its file name (including a directory name).

### Embodiment 2

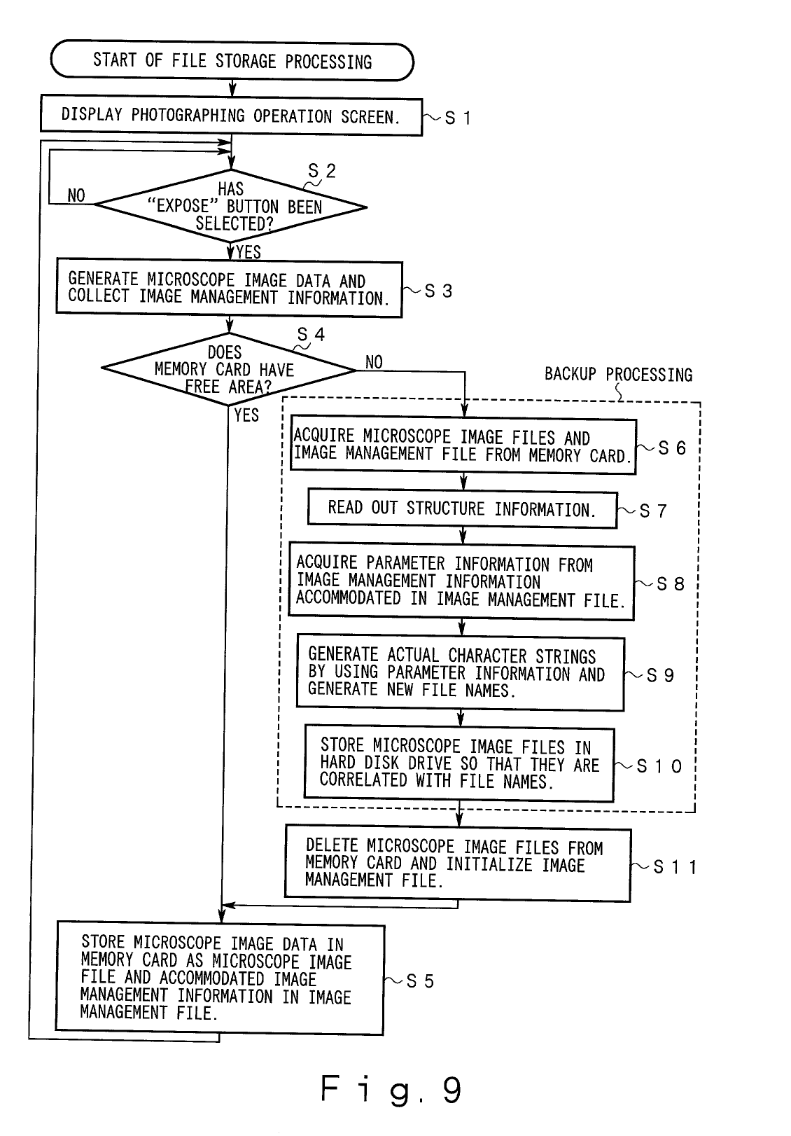

FIG. 9 is an operation flowchart showing a second embodiment of the microscope system 10 according to the present invention.

FIG. 9 shows file storage processing among the various kinds of file management processing to be performed by the CPU 201.

In the second embodiment, backup processing (described later) is performed as part of the file storage processing. The backup processing is performed by using structure information that is input by an operator in advance. Processing for acquiring structure information is the same as the structure information acquisition processing of the first embodiment and hence will not be described below. However, to simplify the description, the second embodiment is directed to an example in which a user-input parameter is not accepted.

In the microscope system 10 according to the second embodiment, the electronic camera 100 is provided with a memory card drive unit (not shown). Microscope image data that are generated by such an electronic camera 100 are stored temporarily as a microscope image file in a memory card that is mounted in the memory card drive unit.

In the microscope system 10 according to the second embodiment, a file (hereinafter referred to as “image management file”) to be used for storing the image management information of all microscope image files stored in each memory card is stored in advance for each memory card. Each image management file may be divided into a plurality of files corresponding to respective microscope image files.

The file storage processing that is performed by the CPU 201 will be described below as an operation of the microscope system 10 according to the second embodiment.

When a command corresponding to the file storage processing is selected by an operator, at step S1 in FIG. 9 the CPU 201 instructs the display controlling section 206 to display a photographing operation screen in the same manner as in the first embodiment (steps S1 and S2 in FIG. 6).

When a photographing operation screen is displayed on the display 212, at step S2 in FIG. 9 the CPU 201 judges whether the “Expose” button has been selected.

If judging that the “Expose” button has been selected, at step S3 in FIG. 9 the CPU 201 instructs the electronic camera 100 to generate microscope image data and instructs the control section of the microscope 101 to collect image management information.

At step S4 in FIG. 9, the CPU 201 judges whether the memory card has a free area. The term “free area” means a free area where to store microscope image data in the form of a microscope image file.

If judging that the memory card has a free area, at step S5 in FIG. 9 the CPU 201 stores the newly generated microscope image data in the memory card in the form of a microscope image file and instructs the electronic camera 100 to cause image management information corresponding to the microscope image file to be stored into the image management file. In storing the microscope image file, the electronic camera 100 gives it a file name that consists of a fixed character string plus a serial number as in the case of conventional electronic cameras.

If judging that the memory card has no free area, at step S11 in FIG. 9 the CPU 201 instructs the electronic camera 100 to delete the microscope image files in the memory card and initialize the image management file in the memory card after performing the backup processing (steps S6-S10 in FIG. 9; described later).

If an area to store a microscope image file is secured in the memory card, at step S5 in FIG. 9 the CPU 201 instructs the electronic camera 100 to store a microscope image file and to cause the image management information to be stored into the image management file.

The backup processing will be described below.

At step S6 in FIG. 9, the CPU 201 acquires, via the microscope interfacing section 207, the microscope image files and the image management file that are stored in the memory card.

At step S7 in FIG. 9, the CPU 201 reads out the structure information from the hard disk drive 208.

At step S8 in FIG. 9, the CPU 201 acquires parameter information corresponding to the parameter names included in the structure information from image management information corresponding to each microscope image file that is stored into the image management file.

At step S9 in FIG. 9, the CPU 201 generates a new file name (including a directory name) corresponding to each microscope image file by generating actual character strings corresponding to the respective parameters using the acquired parameter information and assigning the actual character strings to the respective parameter names in the structure information. However, if “$###” is included in the structure information, the CPU 201 generates a 3-figure serial number and assigns it to “$###” as in the case of the first embodiment.

In this manner, the new file name (including a directory name) of each microscope image file is generated according to the structure information in the same manner as in the first embodiment.

At step S10 in FIG. 9, the CPU 201 stores the microscope image files in the hard disk drive 208 so that they are correlated with the newly generated file names (including a directory name).

As described above, according to the second embodiment, microscope image files in a memory card having no free area can be stored in the hard disk drive 208 without requiring any operations by an operator.

According to the second embodiment, a file name (including a directory name) that reflects desired information or a desired hierarchical file structure can be given to a microscope image file to be stored in the hard disk drive 208 by simple operations of, for example, inputting structure information in advance in the same manner as in the first embodiment. Therefore, in reproducing a desired microscope image file, the manager or a user of the microscope system 10 according to the second embodiment can easily retrieve it by referring to its file name (including a directory name).

In the second embodiment, microscope image data that are generated in a state that the memory card has no free area are stored in the initialized memory card after execution of the backup processing. However, such microscope image data may be stored in the hard disk drive 208 during the backup processing together with the microscope image files in the memory card.

In the second embodiment, processing of giving new file names (including a directory name) corresponding to structure information to the microscope image files in the memory card and storing the microscope image files in the hard disk drive 208 is performed at a time point when the memory card comes to have no free area. However, this processing may be performed at a time point of commanding by an operator.

In the second embodiment, microscope image files are managed by changing their file names to new file names (including a directory name) that are generated at step S9 in FIG. 9. However, microscope image files may be managed by using virtual file names without changing their file names in a manner described below.

When acquiring microscope image files to which file names are given in advance and an image management file, the CPU 201 stores the microscope image files in the hard disk drive 208. After reading out structure information from the hard disk drive 208, the CPU 201 acquires parameter information corresponding to the parameter names included in the structure information from image management information corresponding to each microscope image file that is accommodated in the image management file. The CPU 201 generates actual character strings corresponding to the respective parameters using the acquired parameter information. The CPU 201 generates a virtual file name (including a directory name) corresponding to each microscope image file by assigning the actual character strings to the respective parameter names in the structure information. The CPU 201 correlates the virtual file names with the pre-given file names and manages the microscope image files using the virtual file names (including a directory).

The management using virtual file names can not only be performed during the backup processing but also be performed on any microscope image file stored in advance in the hard disk drive 208 as long as parameter information corresponding to the parameter names included in structure information can be acquired.

### Embodiment 3

FIG. 10 is an operation flowchart showing a third embodiment according to the present invention.

FIG. 10 shows reclassification processing among the various kinds of file management processing to be performed by the CPU 201.

The reclassification processing is processing of re-classifying microscope image files stored in advance in accordance with conditions for classification (hereinafter referred to as “classifying conditions”) that are input by an operator. In the following description, a directory as a subject of reclassification processing will be called “classification source directory”.

In the third embodiment, the reclassification is processing of giving new directory names (hereinafter referred to as “reclassification directory name”) according to a 3-layer structure that conforms to classifying conditions to the microscope image files that belong to a classification source directory. In the following description, classifying conditions corresponding to a highest layer, an intermediate layer, and a lowest layer are called first, second, and third classifying conditions, respectively.

The third embodiment is directed to an example in which as the reclassification processing a table (hereinafter referred to as “classification result table”) showing a corresponding relationship between the file names (including a directory name) of the microscope image files belonging to a classification source directory and reclassification directory names is generated. Processing of changing the directory name of microscope image files to reclassification directory names.

In the third embodiment, a classification result table is stored in a directory (hereinafter referred to as “classification destination directory”) that is set by a manipulator.

That is, according to the reclassification processing of the third embodiment, microscope image files that have been re-classified according to classifying conditions are stored virtually in a classification destination directory.

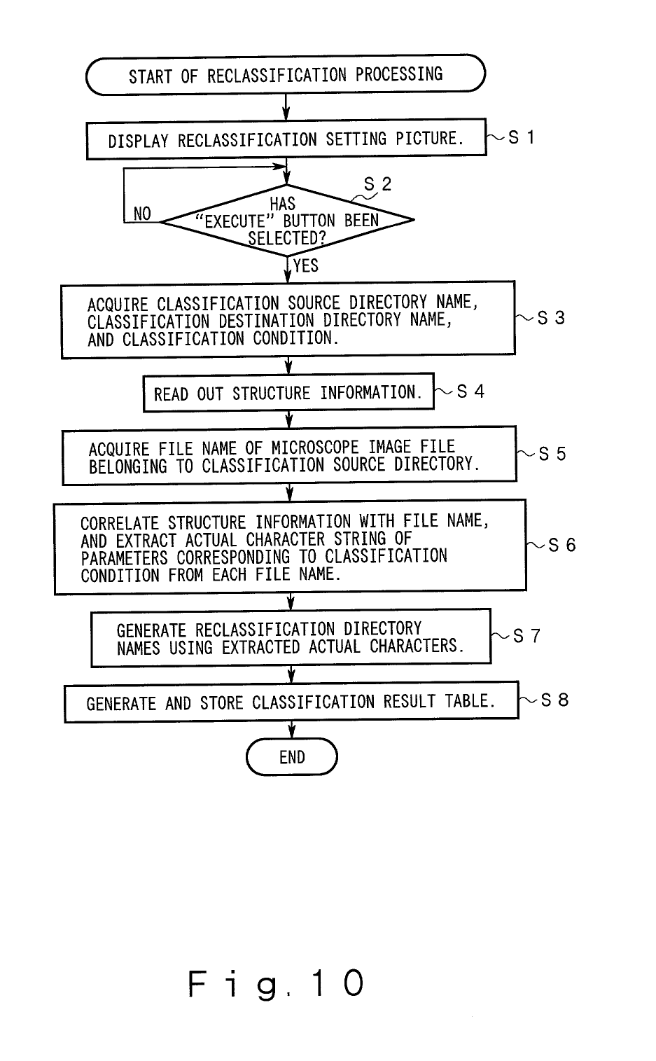

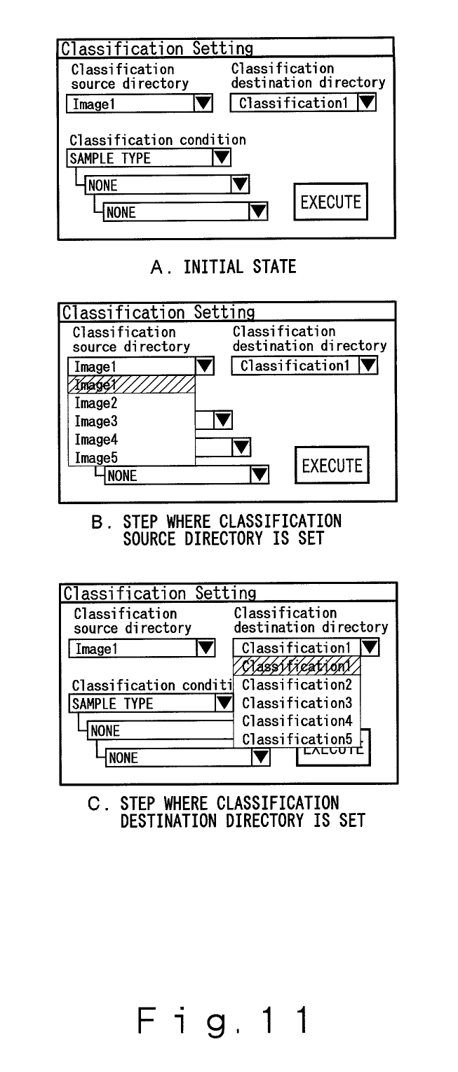

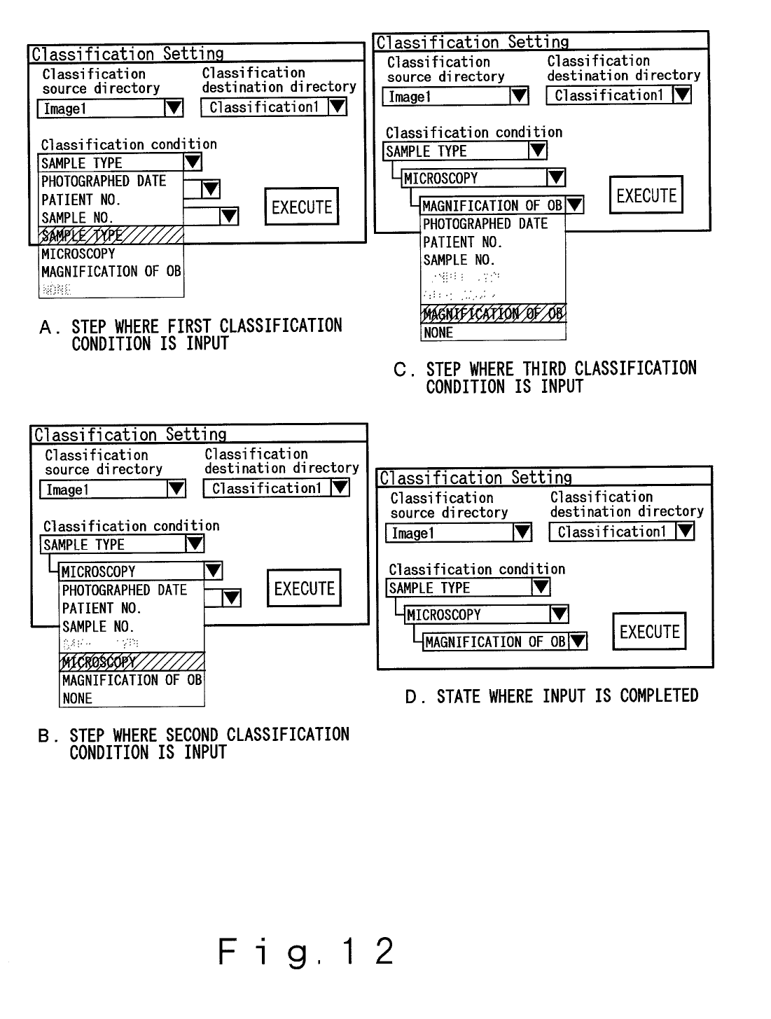

FIGS. 11A-11C and 12A-12D is a third embodiment of an exemplary reclassification-setting screens among the operation screens according to the present invention. The reclassification-setting screen is an operation screen for accepting input of the name of a classification source directory, the name of a classification destination condition, and classifying conditions. The reclassification-setting screen has an “Execute” button for accepting an operator's instruction to execute reclassification processing.

FIG. 11A shows an initial state of a reclassification-setting screen. FIG. 11B shows a state that there is a list having a plurality of directory names where a name could be selected from the list as the name of a classification source directory. FIG. 11C shows a state that a plurality of directory names that can be selected as the name of a classification destination directory are listed. Not only one classification source directory but also a plurality of classification source directories can be selected. A new directory can be set as a classification destination directory.

FIG. 12A shows a state that a plurality of classifying conditions that can be selected as a first classifying condition are listed. FIG. 12B shows a state that a plurality of classifying conditions that can be selected as a second classifying condition are listed. FIG. 12C shows a state that a plurality of classifying conditions that can be selected as a third classifying condition are listed. That is, according to the third embodiment, duplicate or triplicate selection of the same classifying conditions in a plurality of layers is prevented by such a listing display as shown in FIG. 12C. Where the number of classifying conditions is less than three, “None” is selected as a second or third classifying condition.

FIG. 12D shows a state that all inputs have been made.

The reclassification processing that is performed by the CPU 201 will be described below as an operation of the microscope system 10 according to the third embodiment.

In the third embodiment, it is assumed that microscope image files to which file names (including a directory name) are given according to structure information by the file storage processing of the first embodiment or the backup processing of the second embodiment are accommodated in a directory that can be set as a classification source directory.

When a command corresponding to the reclassification processing is selected by an operator, at step S1 in FIG. 10 the CPU 201 instructs the display controlling section 206 to display a reclassification-setting screen as shown in FIG. 11A.

When a reclassification-setting screen is displayed on the display 212, at step S2 in FIG. 10 the CPU 201 judges whether the “Execute” button has been selected.

If judging that the “Execute” button has been selected, at step S3 in FIG. 10 the CPU 201 acquires the name of a classification source directory, the name of a classification destination condition, and classifying conditions that are input by the operator.

At step S4 in FIG. 10, the CPU 201 reads out structure information. That is, the CPU 201 reads out the structure information that was used in generating the file names in the first or second embodiment.

At step S5 in FIG. 10, the CPU 201 acquires the file names (including the directory name) of the plurality of microscope image files that belong to the classification source directory.

At step S6 in FIG. 10, the CPU 201 correlates the structure information with the file names (including the directory name) and extracts the actual character strings of the parameters corresponding to the classifying conditions from each file name.

At step S7 in FIG. 10, the CPU 201 generates a reclassification directory names for the microscope image files connecting the extracted actual character strings using “\”.

At step S8 in FIG. 10, the CPU 201 generates a classification result table by correlating the file names (including the directory name) of the microscope image files belonging to the classification source directory with the reclassification directory names and cause the classification result table to be accommodated in the classification destination directory.

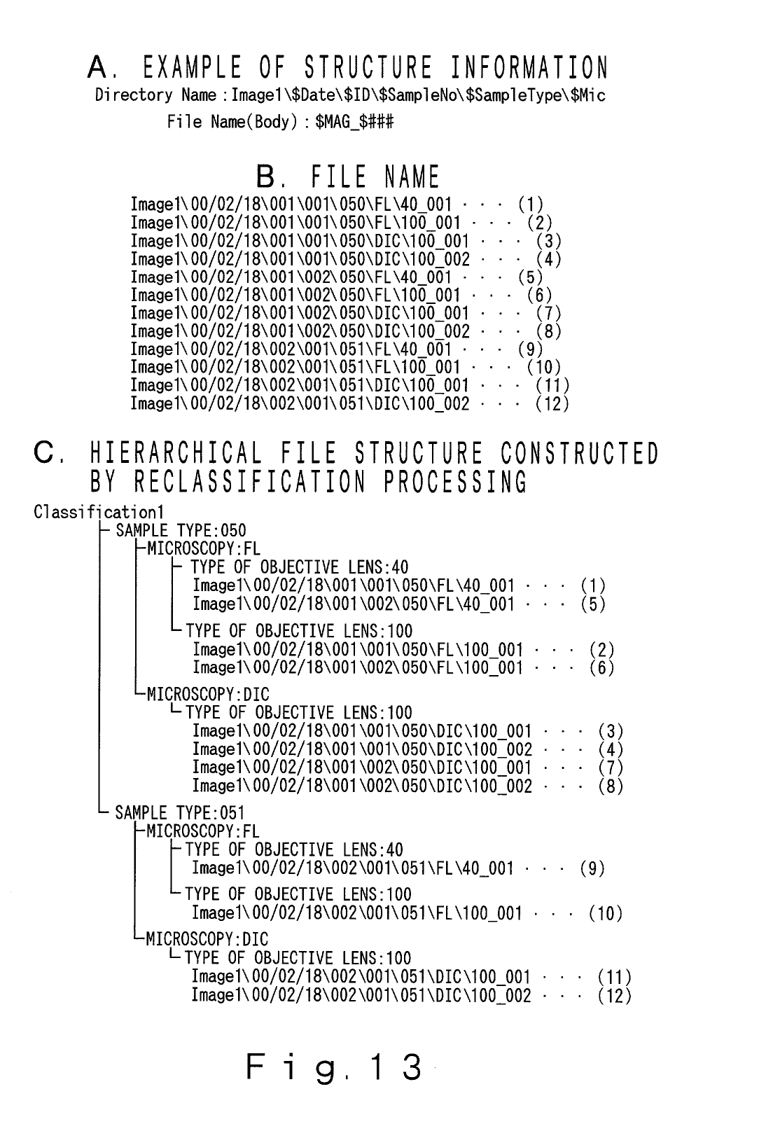

For example, as shown in FIG. 12D, “Image1” is selected as the name of a classification source directory, “Classification1” is selected as the name of a classification destination directory, “Sample type” is selected as a first classifying condition, “Microscopy” is selected as a second classifying condition, and “Magnification of objective lens” is selected as a third classifying condition. Where the directory name of the structure information is “Image 1\$Date\$ID\$SampleNo\$SampleType\$ Mic” and the file name body characters of the structure information is “$MAG_$###” as shown in FIG. 13A, if the CPU 201 acquires “Image 1\00/02/18\001\001\050\FL\40_{—}001” (indicated by symbol (1) in FIG. 13B) as the file name (including a directory name) of a microscope image file belonging to the classification source directory, the CPU 201 correlates the classifying conditions, the parameter names, and the actual character strings with each other in the following manner:

Sample type→$SampleType→050

Microscopy→$Mic→FL

Magnification of objective lens→$MAG→40.

The CPU 201 generates a reclassification directory name “Classification 1\050\FL \40” that corresponds to the file name “Image 1\00/02/18\001\001\050\FL\40_{—}001” (indicated by symbol (1) in FIG. 13B). Similarly, the CPU 201 generates reclassification directory names corresponding to the file names (including the directory name) indicated by symbols (2)-(12) in FIG. 13B.

As a result, the microscope image files that are given the file names indicated by symbols (1)-(12) in FIG. 13B are re-classified according to the hierarchical file structure shown in FIG. 13C.

As described above, according to the third embodiment, the reclassification processing based on information that is reflected in each file name can be performed on microscope image files to which file names (including a directory name) are given by the file storage processing of the first embodiment or the backup processing of the second embodiment.

That is, a user of the microscope system 10 according to the third embodiment can classify desired ones of the microscope image files belonging to a classification source directory according to a desired hierarchical file structure that is different from a hierarchical file structure of the classification source directory.

In the third embodiment, the reclassification processing is realized by causing a classification result table to be accommodated in a classification destination directory. However, the reclassification processing may be realized by copying the microscope image files belonging to a classification source directory to a classification destination directory and changing the directory name of each microscope image file to the name of the classification destination directory. After the change of the directory name, the microscope image files belonging to the classification source directory may be deleted.

In the third embodiment, input of classifying conditions is accepted in the form shown in FIGS. 12A-12D. However, input of classifying conditions may be accepted in the same form as the directory name of structure information is accepted in the first and second embodiments. In the first and second embodiments, a character string including a plurality of parameter names and a prescribed division character (e.g., “_” or “\”) is accepted as the directory name of structure information. However, in the first and second embodiments, the directory name of structure information may be accepted in the same form as in the third embodiment.

In the third embodiment, to generate a reclassification directory name, the actual character strings included in a file name (including a directory name) that is generated according to structure information. Such actual character strings included in a file name may be used in performing conditional thumbnail display processing, which is processing of displaying only thumbnail images of microscope image files that satisfy a condition that is input by an operator (hereinafter referred to as “displaying condition”) among pre-stored microscope image files before their reproduction.

The conditional thumbnail display processing will be described below.

The CPU 201 accepts input of a displaying condition and the name of a directory as a subject of the conditional thumbnail display processing. At this time, it is necessary to input a parameter name and an actual character string as a displaying condition. For example, if an operator desires to display a thumbnail image of a microscope image file whose sample number is “001”, he inputs “$SampleNo” and “001”.

The CPU 201 reads out structure information and acquires the file names (including a directory name) of a plurality of microscope image files belonging to a directory as the subject of the conditional thumbnail display processing. The CPU 201 analyzes each file name based on the structure information.

The CPU 201 selects file names (including a directory name) including the actual character string corresponding to the displaying condition, and instructs the display controlling section 206 to display thumbnail images of the microscope image files corresponding to those file names.

As a result, only thumbnail images of the microscope image files satisfying the displaying condition are displayed on the display 201.

Therefore, a user of the microscope system 10 is required only to search for thumbnail images corresponding to desired microscope image files from the thumbnail images to which limitation has been made using the displaying condition. The search can be performed faster than in a case where thumbnail images of microscope image files that do not satisfy the displaying condition are displayed.

Each of the above embodiments is directed to the file management of microscope image files of the microscope system 10. However, the application range of the invention is not limited to it and the invention can be applied to file management of any kind of files. However, in file management of files other than microscope image files, parameters included in structure information need to be changed to parameters that are suitable for identification of each file.

In each of the above embodiments, the CPU 201 of the personal computer 200 performs the file management. However, an electronic camera or an apparatus dedicated to file management may perform similar file management.

The invention is not limited to the above embodiments and various modifications may be made without departing from the spirit and scope of the invention. Any improvement may be made in part or all of the components.

What is claimed is:

1. A file management apparatus comprising:
a structure information setting section capable of arbitrarily setting structure information that defines structure of a file name;
a data acquiring section for acquiring data to be stored as a file;
a name-generating section for acquiring, for each data acquired by said data acquiring section, information structuring a file name, according to the structure information that is set by the structure information setting section, to generate a file name using the acquired information; and
a managing section for storing the data acquired by the data acquiring section, and for managing the data using the file names generated by the name-generating section.

2. The file management apparatus according to claim 1, wherein:
the data acquiring section acquires stored data to which a file name is given in advance and information that is associated with the stored data; and
the name-generating section acquires, for each data acquired by said data acquiring section, information structuring a file name, from said associated information according to the structure information that is set by the structure information setting section, to generate a new file name using the acquired information.

3. The file management apparatus according to claim 1, wherein:
said data acquiring section acquires microscope image data of a sample that is photographed by an imaging device that is part of a microscope system; and
said structure information setting section can set, as said structure information, a characteristic of the microscope image data to be reflected in a file name of said microscope image data.

4. The file management apparatus according to claim 1, further comprising:
a classifying condition setting section capable of setting arbitrarily a classifying condition to be used for classifying data stored in the managing section into a plurality of groups; and
a classifying section for acquiring information corresponding to said classifying condition from the file names of the data stored in said managing section, to classify data having the same said information acquired corresponding to said classifying condition into a same group, wherein
said managing section manages, data stored therein in advance, in two ways, which are managing by the file names generated by the name-generating section and managing by a result of classifying by the classifying section.

5. The file management apparatus according to claim 1, further comprising:
a thumbnail display section for displaying a thumbnail image that is a reduced image of an image corresponding to the data stored in said managing section; and
a displaying condition setting section for setting, as a displaying condition to be used for selecting the thumbnail image to be displayed by the thumbnail display section, information that is included in the file name corresponding to the thumbnail image to be displayed, wherein
said thumbnail display section selects the file name including the information that is set as the displaying condition by the displaying condition setting section, from file names of the data stored in said managing section, and displays the thumbnail image corresponding to the selected file name.

6. A file management apparatus comprising:
a data acquiring section for acquiring stored data to which a file name is given in advance and information that is associated with the stored data;
a structure information setting section capable of arbitrarily setting structure information that defines a structure of a virtual file name; and
a name-generating section for acquiring, for each data acquired by said data acquiring section, information structuring a virtual file name, according to the structure information that is set by the structure information setting section, to generate a virtual file name using the acquired information, wherein
said data acquired by said data acquiring section are managed by using the virtual file name generated by the name-generating section.

7. A computer readable medium storing a file management program to control a computer, said program comprising the steps of:
setting arbitrarily structure information that defines structure of a file name;
acquiring data to be stored as a file;
acquiring, for each data acquired by said data acquiring step, information structuring a file name, according to the structure information that is set by the structure information setting step, to generate a file name using the acquired information; and
storing the data acquired by the data acquiring step, and managing the data using the file name generated by the name-generating step.

8. The computer readable medium according to claim 7, wherein:
said data acquiring step acquires stored data to which a file name is given in advance and information that is associated with the stored data; and
said name-generating step acquires, for each data acquired by said data acquiring step, information structuring a file name, from said associated information according to the structure information that is set by the structure information setting step, to generate a new file name using the acquired information.

9. The computer readable medium according to claim 7, wherein:
said data acquiring step acquires microscope image data of a sample that is photographed by an imaging device that is part of a microscope system; and
said structure information setting step can set, as said structure information, a characteristic of the microscope image data to be reflected in a file name of said microscope image data.

10. The computer readable medium according to claim 7, further comprising:
a classifying condition setting step capable of setting arbitrarily a classifying condition to be used for classifying data stored by the managing step into a plurality of groups; and
a classifying step of acquiring information corresponding to said classifying condition from the file names of the data stored by said managing step, to classify data having the same information acquired corresponding to said classifying condition into a same group, wherein
said managing step manages data stored thereby in advance, in two ways, which are managing by the file names generated by the name-generating step and managing by a result of classifying by the classifying step.

11. The computer readable medium according to claim 7, further comprising:
a thumbnail display step for displaying a thumbnail image that is a reduced image of an image corresponding to the data stored by said managing step; and
a displaying condition setting step for setting, as a displaying condition to be used for selecting the thumbnail image to be displayed by the thumbnail display step, information that is included in the file name corresponding to the thumbnail image to be displayed, wherein
said thumbnail display step selects file name including the information that is set as the displaying condition by the displaying condition setting step, from file names of the data stored by said managing step, and displays the thumbnail image corresponding to the selected file name.

12. A computer readable medium storing a file management program to control a computer, said program comprising the steps of:
acquiring stored data to which a file name is given in advance and information that is associated with the stored data;
setting arbitrarily structure information that defines structure of a virtual file name; and
acquiring, for each data acquired by said data acquiring step, information structuring a virtual file name, according to the structure information that is set by the structure information setting step, to generate a virtual file name using the acquired information, wherein
said data acquired by said data acquiring step are managed by using the virtual file name generated by the name-generating step.
